(19) United States
(12) Patent Application Publication
(10) Pub. No.: US 2023/0159005 A1
(43) Pub. Date: May 25, 2023

(54) SUPPORTING TRAILERS

(71) Applicant: Nova Southeastern University, Fort Lauderdale, FL (US)

(72) Inventors: Kaija Ranglin, Fort Lauderdale, FL (US); Onesiphore Augustin, Fort Lauderdale, FL (US); Ian Trotta, Fort Lauderdale, FL (US); Ali Keshavarz Panahi, Fort Lauderdale, FL (US)

(73) Assignee: Nova Southeastern University, Fort Lauderdale, FL (US)

(21) Appl. No.: 17/920,825

(22) PCT Filed: Apr. 27, 2021
(86) PCT No.: PCT/US21/29339

§ 371 Date: Oct. 24, 2022

Related U.S. Application Data
(60) Provisional application No. 63/017,800, filed on Apr. 30, 2020.

(51) Int. Cl. B60S 9/08

(52) U.S. Cl. CPC B60S 9/08

(57) ABSTRACT

A system for controlling extension and retraction of trailer landing gear of a trailer, with the landing gear including a shaft which is rotated to retract and extend the landing gear and the trailer further including a source of electricity. The system comprises: an electric motor having an output shaft disposed 90 degrees with respect to a longitudinal axis of the motor; a mounting plate affixable to the trailer landing gear, with the motor affixable to the mounting plate, the mounting plate sized and dimensioned to position the output shaft in axial alignment and adjacent to an end of the landing gear shaft, and to position the motor outboard of the trailer landing gear; and the motor connectable to the source of electricity to rotate and cause retraction or extension of the trailer landing gear.

### FIELD OF THE DISCLOSURE

The disclosure relates to a system and method for supporting detached trailers, and more particularly, to electrically extending and retracting trailer landing gear legs.

### BACKGROUND

Trailer landing gear include retractable legs that keep a towable trailer upright and stable when the towing vehicle is removed. They are most commonly used with heavy trailers, such as a semi-trailer. Typically, two landing legs are positioned near the forward end and underneath the trailer, and support the trailer so that the towing vehicle can be detached, or in the case of a semi-trailer, the truck can be driven out from under the trailer. To enable the landing gear to be raised and lowered, a system of reduction gears are used so that a single person can cause the landing gear to lift the heavy weight of the trailer by turning a hand crank many times. The current trailer landing gear system used on semi-trailers is therefore time consuming and tedious for truck drivers to use, and can produce repetitive motion injuries.

### SUMMARY

The disclosure relates to a system for controlling extension and retraction of trailer landing gear of a trailer, with the landing gear including a shaft which is rotated to retract and extend the landing gear. The system comprises: an electric motor having an output shaft disposed 90 degrees with respect to a longitudinal axis of the motor; a mounting plate affixable to the trailer landing gear, the motor affixable to the mounting plate, the mounting plate sized and dimensioned to position the output shaft in axial alignment and adjacent to an end of the landing gear shaft, and to position the motor outboard of the trailer landing gear; and the motor connectable to the source of electricity to rotate and cause retraction or extension of the trailer landing gear.

The motor can include a rotor shaft connected to a 90 degree gear set, the output shaft connected to the gear set, the 90 degree gear set releasably attachable to the motor. The system can further include an electric switch electrically connected to the source of electricity and the motor to cause the motor to rotate in a first direction, a second direction, and to stop rotation, whereby the switch can be used to control extension and retraction of the landing gear. In an embodiment, the system can further include a relay connected to the switch, the motor, and the source of electricity, the switch connected in a circuit with the relay to activate the relay to cause the motor to be electrically energized.

The system can also include an adapter having a first end sized and dimensioned to securely couple to the output shaft, the adapter having a second end sized and dimensioned to securely couple to the landing gear shaft. The system can also have a reinforcing plate attachable to the trailer landing gear and the mounting plate. In this regard, the reinforcing plate can be provided with openings at predetermined locations corresponding to locations of existing openings in the trailer landing gear, whereby mounting bolts can be positioned through the reinforcing plate and the trailer landing gear.

The mounting plate can be provided with openings at predetermined locations corresponding to locations of existing openings in the trailer landing gear, whereby mounting bolts can be positioned through the mounting plate and the trailer landing gear. Additionally, one or more mounting bolts can each be positioned through the mounting plate and the trailer landing gear and the reinforcing plate.

In an embodiment, the trailer landing gear is of the type including a movable leg portion and fixed leg portion. The system can include a movable limit contact affixed to the movable leg portion, and at least one fixed limit contact affixed to the fixed leg portion. The movable limit contact and the at least one fixed limit contact are mutually cooperative to limit an extent of movement of the movable leg portion and the fixed leg portion when the movable limit contact and the fixed limit contact are at least one of mutually in contact and mutually in proximity. At least one of the movable contact and the at least one fixed contact can be an electrical switch. The electrical switch can be connected to an electrical circuit operative to interrupt a supply of electrical power to the motor. Further, at least one fixed limit contact can be positioned above the movable limit contact to control retraction of the landing gear, and at least one fixed limit contact can be positioned below the movable limit contact to control extension of the landing gear.

The shaft of the landing gear can be either an input shaft connectable to a handle and connected to reduction gears or a transverse shaft not connected to reduction gears, with the motor output shaft connectable to either the input shaft or the transverse shaft.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a prior art semi trailer;

FIG. 2 depicts an underside of a prior art semi trailer together with prior art trailer landing gear;

FIG. 3 depicts a detail of prior art landing gear;

FIG. 4 is a perspective view of trailer landing gear provided with a landing gear extension and retraction system of the disclosure;

FIG. 5 is an alternative perspective view of the system of FIG. 4;

FIG. 6 is a detailed alternative perspective view of a portion of the system of FIG. 4;

FIG. 7 is a detailed alternative perspective view of a portion of the system of FIG. 4;

FIG. 8 is a perspective view of a mounting bracket in accordance with the disclosure, dismounted from the system of FIG. 4;

FIG. 9 is a detailed perspective view of a dismounted motor and gear system of the system of FIG. 4;

FIG. 10 is a detailed perspective view of an adapter in accordance with the disclosure, dismounted from the system of FIG. 4;

FIG. 11 is a detailed perspective view of an opposite side of the adapter of FIG. 10;

FIG. 12 is a perspective view of a reinforcing plate of the disclosure, dismounted from the system of FIG. 4;

FIG. 13 is a perspective view of a movable limit contact of the disclosure, dismounted from the system of FIG. 4, as best seen in FIG. 15;

FIG. 14 is a side view of the system of FIG. 4;

FIG. 15 is a front view of the system of FIG. 4; and

FIG. 16 is a detailed alternative perspective view of the system of FIG. 4, showing prior art reduction gears positioned inboard of a landing gear mounting frame.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

The disclosure provides an automated trailer landing gear system 100 for replacing or augmenting the current landing gear crank system. The system can be powered by the electrical system of the truck as connected to the trailer, and can be controlled by a switch mounted to the trailer, or by a remote control.

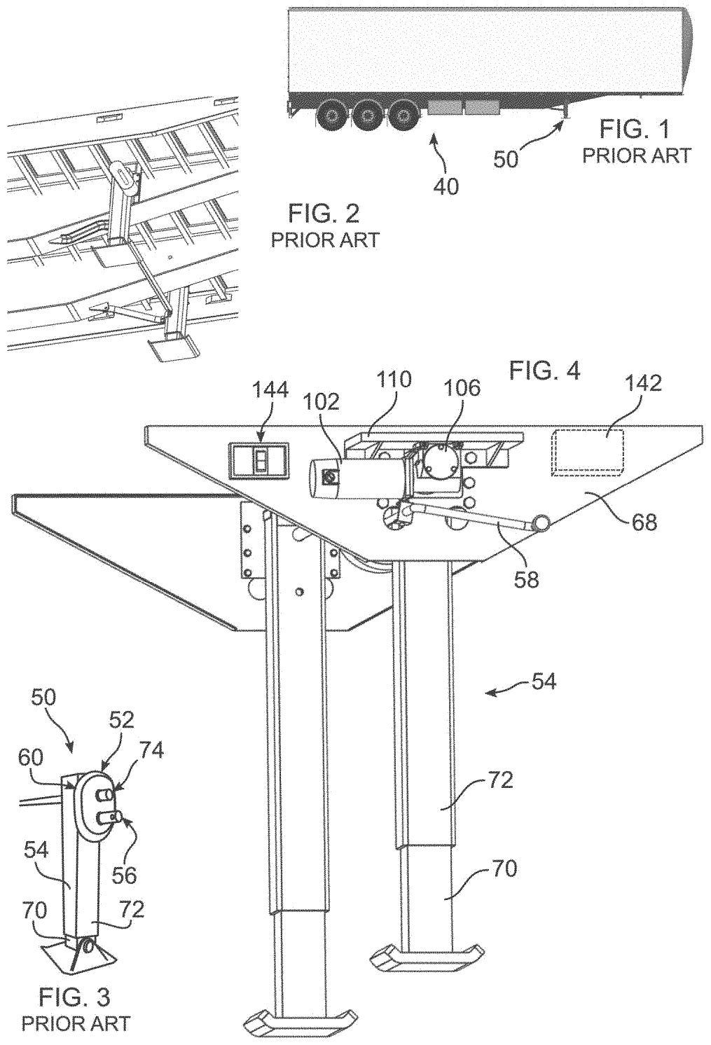

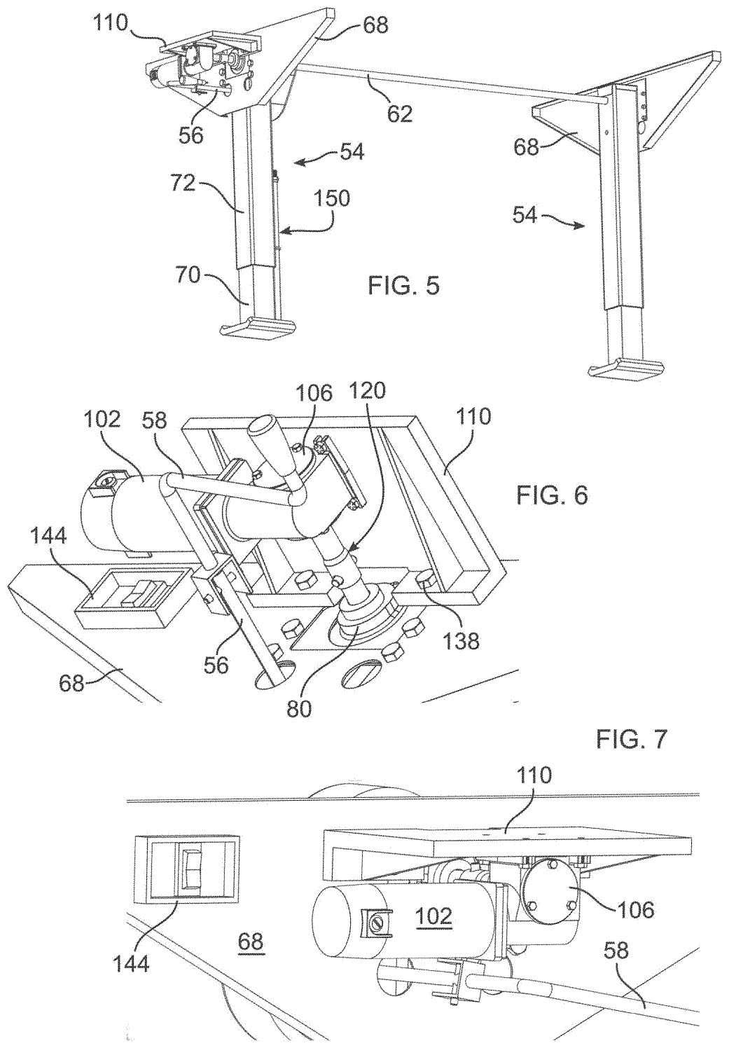

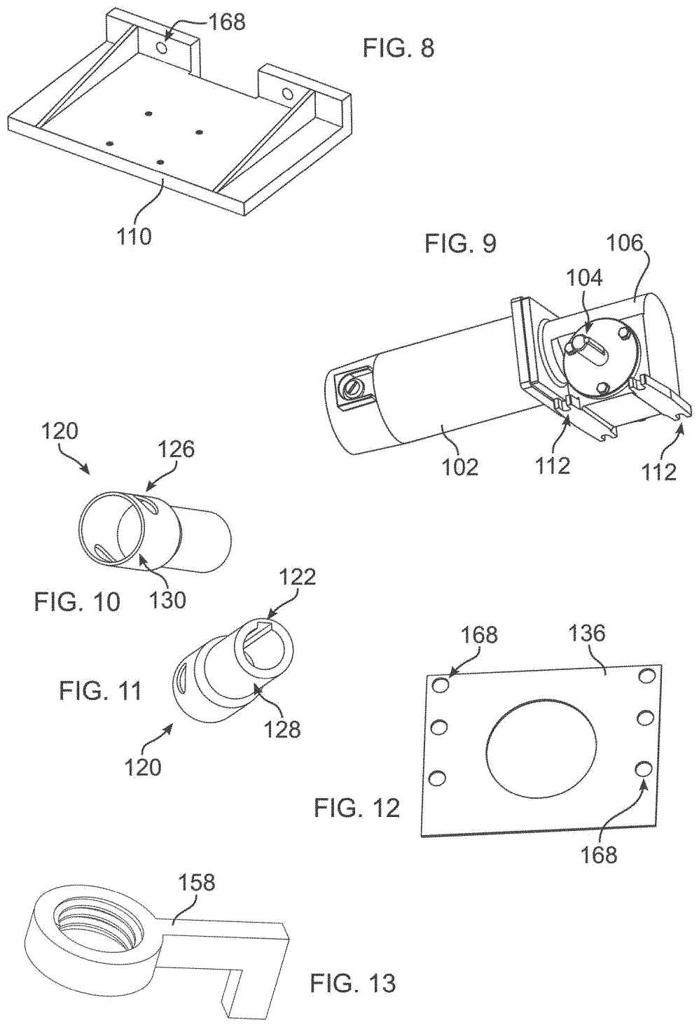

Prior art landing gear systems 50 are shown in FIGS. 1-3. In FIG. 1, landing gear system 50 is positioned under a forward portion of the trailer 40, leaving space forward for the frame, wheels, and fifth wheel of a semi-truck (not shown) to pass underneath. FIG. 2 provides a detailed view. With reference to FIGS. 3 and 16, a reduction gear system 52 is positioned on an outer surface of a landing gear leg 54.

Additionally, an input shaft 56 is connectable to a crank handle 58. As input shaft 56 is rotated, reduction gears 60, for example as can be seen in FIG. 16, cause rotation of a transverse shaft 62. Input shaft 56 typically extends from one landing leg set to the other landing let set, so that both legs move up or down simultaneously.

Further in accordance with the prior art, bevel gears 64 or the like engage a gear 78 on transverse shaft 62 to thereby translate rotation of transverse shaft 62 ninety degrees to a vertical threaded shaft 66. As threaded shaft 66 turns, threads (not shown) engage an internal plate (not shown) mounted to a lower leg segment 70, which causes relative motion between lower leg segment 70 and an upper leg segment 72, which causes telescoping of the leg 54. A mounting frame 68 connects leg 54, and other components cooperative with leg 54, to the trailer 40. Typically, handle 58 is pushed in or pulled out to alternately cause the engagement of faster or slower reduction gears. Reduction gears 60 can be positioned outboard of frame 68 or inboard of frame 68. Typically, transverse shaft 62 extends beyond reduction gears 60 to a stub 74. In some versions of landing gear, stub 74 includes a cross-bore so that hand crank 58 can be connected directly to transverse shaft 62.

In accordance with the disclosure, system 100 can be implemented to cooperate with the various permutations of the prior described herein. An output shaft 104 of an electric motor 102 is connected to either stub 74 or input shaft 56 to cause actuation of the landing gear when motor 102 is energized and output shaft 104 rotates. As can be seen in the figures, motor 102 is provided with a 90 degree output gear set 106, which has an output shaft having an axis that is oriented 90 degrees with respect to both a longitudinal axis and a rotor rotational axis of the motor. Gear set 106 enables an alignment of motor 102 along a longitudinal axis of the trailer when motor 102 is installed. In this manner, motor 102 does not project beyond a periphery of the trailer; does not interfere with manual operation of the landing gear via crank 58; and a larger motor can be accommodated. In an embodiment, motor 102 has an integrated 90 degree output shaft.

A mounting plate 110 is attachable to the trailer, for example to the trailer 40 frame or to mounting frame 68, the latter as shown in the figures. Mounting plate 110 is positioned to cause alignment of output shaft 104 with input shaft 56 or stub 74 of transverse shaft 62, as determined in accordance with a predetermined configuration plan. Mounting plate 110 can be connected to trailer 40 or mounting frame 68 by bolts, welding, press fit, or any other manner which provides sufficient strength and reliability. Likewise, motor 102 and attached gear set 106 are attached to mounting plate 110, for example using mounting points 112 provided with gear set 106. In the embodiment shown, mounting plate 110 extends at a right angle from mounting frame 68, and motor 102 is attached to hang from an underside of mounting plate 110, on an outboard side of the landing gear. More particularly, mounting plate 110, as shown in the figures, can be dimensioned to position motor 102 on an outer side of mounting frame 68, where it is easiest to mount and maintain motor 102 and associated components. This mounting location additionally avoids landing gear reinforcing bars and other structure which is typically located inboard of mounting frame 68 (see e.g. prior art FIG. 2).

An adapter 120 can be used to couple motor 102 output shaft 104 to input shaft 56 or stub 74. A keyway 122 can be provided within a first end 128 of the adapter to mate with a corresponding key 124 on the output shaft 104, or a corresponding keyway on output shaft 104, into which a locking key can be inserted. Alternatively, a mating spline, a flexible coupling, or any other means of coupling output shaft 104 with adapter 120 can be provided.

At a second end 130 of adapter 120, a transverse bore 126 is provided, which can be mated with input shaft 56 in a like manner as handle 58, for example with a pin or bolt, provided a mating transverse bore is also formed through the shaft to be mated. To enable use of adapter 120 on stub 74, which may not have a transverse bore, a bore can be drilled through stub 74 to accommodate a mounting pin, or second end 130 can be sized to fit over stub 74, and attached through an interference fit, threading, welding, or any other method.

By connecting directly to transverse shaft 62, system 100 can be attached without disassembly or replacement of the existing gear system 52. In addition, when system 100 is connected to transverse shaft 62, the manual crank system remains intact and usable as before.

In an embodiment, as can be seen in FIG. 12, a reinforcing plate 136 is positioned against mounting frame 68 to provide additional strength for mounting frame 68, and in particular to strengthen an attachment of mounting plate 110. As motor 102 is mounted a distance from mounting frame 68, and as mounting plate 110 extends at a right angle from mounting frame 68, a substantial bending force could be exerted upon mounting frame 68, particularly while motor 102 is operating. Reinforcing plate 136 is attached to lie against mounting frame 68 and to clamp mounting frame 68 between mounting plate 110 and reinforcing plate 136, to thereby counteract this bending force. Reinforcing plate 136 can be attached to mounting frame by any known means, including bolts, as shown, or by welding, adhesive, or any other means. As can be seen in FIG. 6, reinforcing plate 136 is advantageously also connected to mounting plate 110, for example by bolts 138. In addition to various mounting bolt through holes 140, a central aperture enables passage of transverse shaft 62 and associated bearing 80. Openings 168 in reinforcing plate 136 as well as mounting plate 110 can be positioned to correspond with existing openings in mounting frame 68, thereby avoiding a requirement of drilling holes for mounting bolts.

Motor 102 can be energized by electrical power that is already present throughout the trailer. A motor switch 144 controls operation of motor 102, and has an off position, and two running positions: retract (up), and extend (down). Switch 144 can be attached to mounting frame 68, the trailer body, or to any other location convenient for a user of system 100.

Motor 102 can be configured to rotate in a first direction when a positive voltage is applied, and a second, opposite direct when reverse voltage is applied, which can be carried out by the two miming positions of switch 144. An electrical circuit can be provided for reversing rotational direction, if required by the motor. Likewise, a reversing transmission can alternatively or additionally be provided as required or specified. Switch 144 can be connected to a relay by smaller wires, for safety and ease of mounting and positioning.

Switch 144 can alternatively or additionally have the form of a remote control (not shown) so that an operator can stand clear as the landing gear operates. Communication electronics for the remote control (not shown) would therefore be provided in the motor control circuit described herein.

Power can be provided by a battery or generator associated with the trailer, although it can be simpler to use power provided to the trailer by the towing vehicle. Trailer connectors used throughout the world typically include at least one pin/line which is electrically powered at all times, and which can provide the requisite electrical supply. Examples of such powered lines in heavy trucks in North America can be found in a typical 7-way SAE J560 specification connection between the tractor and the trailer. More particularly, this specification includes an ‘aux and ABS power’ line. In some configurations of this specification, there are alternatively ‘electric brakes’ and ‘aux power’ lines. Other configurations, including 5- and 6-way specifications, may include an ‘electric brakes’ line. All of the foregoing specifications, as well as a 4-way specification, include a ‘tail lights’ line.

Logically, an ‘aux power’ or other line designated for auxiliary systems would be an optimal choice, as it is not necessarily connected to safety-oriented lighting or braking systems. This is particularly important when retrofitting a trailer with a system 100 of the disclosure, as alteration of an electrical system after manufacture can introduce points of failure. A second choice would be a ‘tail lights’ line, and a last choice would be a line relating to braking, unless it is otherwise designated for auxiliary equipment. Manufacturer guidelines should be consulted, and would of course take precedence to any of the above.

Wires leading from the connector travel through races or other passages, usually along the underside of the trailer. An appropriate wire representing the desired line connection can be selected, and an additional wire can be spliced onto this line for supplying switch 144, and ultimately motor 102. Alternatively, a designated wire can be extended between switch 144 and a junction box associated with the trailer connector.

Where motor 102 requires a larger “startup” amount of power, a capacitor or other motor starter circuit can be provided. If motor 102 requires more power than can be provided in real time by the selected line, a battery 142 of sufficient size, and a charging circuit, can be connected to the selected line, and the battery can thereafter provide the startup power, supplemental power, or all of the power required by motor 102 during use. Between uses, the battery can “trickle charge” without taxing the electrical system of the towing vehicle. Alternatively, a solar recharging system can be used, or a recharging system associated with parts of the trailer which rotate during use, or any other regenerative system. The battery and charging circuit can be positioned in any convenient location. If the battery is a lithium or other highly efficient type battery, it can be small and easily positioned underneath the trailer or upon mounting frame 68, or upper leg segment 72, for example. It should be understood that switch 144, motor 102, wiring, and any battery system should be adapted for the voltage available, typically 12 or 24 volts, and the maximum wattage requirements.

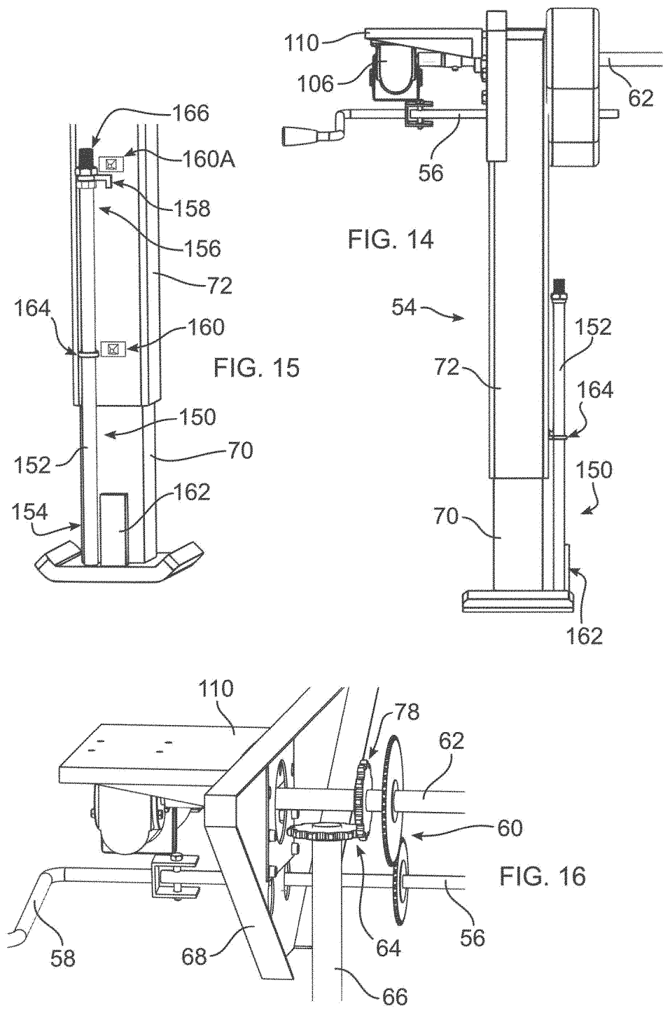

Further in accordance with the disclosure, a sensor system 150 is provided for controlling an extent of retraction and extension of lower leg segments 70. Limiting over-extension or over retraction is advantageous, particularly where motor 102 is sufficiently powerful to cause damage to components of leg 54 at the limits of travel. With reference to FIGS. 14-15, a shaft 152 is affixed to lower leg segment 70 at a shaft lower end 154, and is optionally slidingly supported at a distance up from the lower end by a ring anchor 164 positioned upon upper leg segment 72. A movable limit contact 158 is positioned upon shaft 152 near a shaft upper end 156. As a result, as lower leg moves, a position of movable limit contact 158 changes with respect to upper leg segment 72. Shaft 152 can be hollow, to enable wiring to extend from movable limit contact 158 to a transmitter or control circuit; alternatively any shape supporting member can be used.

A extend limit contact 160 is positioned upon upper leg segment 172 at a distance below movable limit contact 158, the distance corresponding to an extent of extension of leg 54. When leg 54 is fully extended, movable limit contact 156 interacts with extend limit contact 160, which causes interruption in the electrical supply to motor 102. Movable limit contact 158 can be positioned upon a threaded portion 166 of shaft 152, or can otherwise be adjustably positioned upon shaft 152, so that the limit of extension can be adjusted. In an embodiment, movable limit contact is threaded (FIG. 13).

It should be understood that shaft 152 and movable limit contact can be affixed to upper leg 72, and lower leg can include the one or more fixed limit contacts.

In one embodiment, one or both of movable limit contact 158 and extend limit contact 160 is an electrical switch, for example a momentary style of switch, and the interaction is caused by proximity or contact between the two limit contacts 156, 160. Examples of switch styles include mechanical or magnetically activated. These switches can be wired to a wireless transmitter, for example located within case 162 or elsewhere, or can be wired directly back to a motor control circuit (not shown), or one or more of the switches can include a wireless transmitter. Where a wireless transmitter is used, it can communicate with the motor control circuit. Where the switches are wired, they can be electrically connected to a circuit which includes a relay operative to interrupt a supply of electricity to the motor.

In another embodiment, shaft 152 is raised or urged upwards by the contact of movable limit contact and extend limit contact 156, 160, activating a switch or sensor associated with or within case 162 positioned at shaft lower end 154. As examples, case 162 can include any or all of a strain gauge, mechanical switch, magnetic switch, proximity sensor, light sensor, or other sensor type. Any of the foregoing sensors or switches, whether mechanical or otherwise, can be protected within an enclosure or seal to keep out moisture or debris.

Setting a retract limit can be accomplished in the same manner as described for an extend limit, except that retract limit contact 160A is positioned above movable limit contact 158, but is otherwise activated as described with respect to the combination of limit contacts 158 and 160. Alternatively, in one embodiment, case 162 is rigid, and interferes with upper leg 72 at a limit of retraction, and is thus sized with an appropriate height.

In an embodiment, the disclosure is carried out with only 6 parts, including motor 102, 90 degree output gear set 106, mounting plate 110, reinforcing plate 136, switch 144, and adapter 120. All of these components are positionable outboard of mounting frame 68, greatly facilitating installation. Mounting and reinforcing plates 110, 136 can be provided for each model of landing gear commonly used, each including bolt hole openings 168 which correspond to existing bolt hole openings in mourning frame 68, whereby no holes need to be drilled for installation. However, if it is necessary to drill holes, all parts are easily accessed from beside, and not under, the trailer.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A system for controlling extension and retraction of trailer landing gear of a trailer, the landing gear including a shaft which is rotated to retract and extend the landing gear, the trailer further including a source of electricity, the system comprising:
an electric motor having an output shaft disposed 90 degrees with respect to a longitudinal axis of the motor;
a mounting plate affixable to the trailer landing gear, the motor affixable to the mounting plate, the mounting plate sized and dimensioned to position the output shaft in axial alignment and adjacent to an end of the landing gear shaft, and to position the motor outboard of the trailer landing gear;
the motor connectable to the source of electricity to rotate and cause retraction or extension of the trailer landing gear.

2. The system of claim 1, where the motor includes a rotor shaft connected to a 90 degree gear set, the output shaft connected to the gear set, the 90 degree gear set releasably attachable to the motor.

3. The system of claim 1, further including an electric switch electrically connected to the source of electricity and the motor to cause the motor to rotate in a first direction, a second direction, and to stop rotation, whereby the switch can be used to control extension and retraction of the landing gear.

4. The system of claim 3, further including a relay connected to the switch, the motor, and the source of electricity, the switch connected in a circuit with the relay to activate the relay to cause the motor to be electrically energized.

5. The system of claim 1, further including an adapter having a first end sized and dimensioned to securely couple to the output shaft, the adapter having a second end sized and dimensioned to securely couple to the landing gear shaft.

6. The system of claim 1, further including a reinforcing plate attachable to the trailer landing gear and the mounting plate.

7. The system of claim 6, the reinforcing plate provided with openings at predetermined locations corresponding to locations of existing openings in the trailer landing gear, whereby mounting bolts can be positioned through the reinforcing plate and the trailer landing gear.

8. The system of claim 1, the mounting plate provided with openings at predetermined locations corresponding to locations of existing openings in the trailer landing gear, whereby mounting bolts can be positioned through the mounting plate and the trailer landing gear.

9. The system of claim 7, the mounting plate provided with openings at predetermined locations corresponding to locations of existing openings in the trailer landing gear, whereby one or more mounting bolts can each be positioned through the mounting plate and the trailer landing gear and the reinforcing plate.

10. The system of claim 1, the trailer landing gear of the type including a movable leg portion and fixed leg portion, the system further including a movable limit contact affixed to the movable leg portion, and at least one fixed limit contact affixed to the fixed leg portion, the movable limit contact and the at least one fixed limit contact mutually cooperative to limit an extent of movement of the movable leg portion and the fixed leg portion when the movable limit contact and the fixed limit contact are at least one of mutually in contact and mutually in proximity.

11. The system of claim 10, wherein at least one of the movable contact and the at least one fixed contact is an electrical switch.

12. The system of claim 11, the electrical switch connected to an electrical circuit operative to interrupt a supply of electrical power to the motor.

13. The system of claim 10, at least one fixed limit contact positioned above the movable limit contact to control retraction of the landing gear, and at least one fixed limit contact positioned below the movable limit contact to control extension of the landing gear.

14. The system of claim 1, the shaft of the landing gear being either an input shaft connectable to a handle and connected to reduction gears or a transverse shaft not connected to reduction gears, the motor output shaft connectable to either the input shaft or the transverse shaft.
